(19) United States
(12) Patent Application Publication
(10) Pub. No.: US 2020/0250231 A1
(43) Pub. Date: Aug. 6, 2020

(54) SYSTEMS AND METHODS FOR DYNAMIC INGESTION AND INFLATION OF DATA

(71) Applicant: Nodin Inc., Denver, CO (US)

(72) Inventors: Robert Brian Seigel, Denver, CO (US); Curtis Ray Eubanks, Lakewood, CO (US); Pierre Elisseeff, Cincinnati, OH (US); David Tarasi, Denver, CO (US); Gary Dolliver, Aurora, CO (US); Eugeniu Cazacu, Denver, CO (US)

(21) Appl. No.: 16/848,928

(22) Filed: Apr. 15, 2020

Related U.S. Application Data
(63) Continuation-in-part of application No. 16/141,751, filed on Sep. 25, 2018.
(60) Provisional application No. 62/834,298, filed on Apr. 15, 2019.
(60) Provisional application No. 62/625,645, filed on Feb. 2, 2018.
(60) Provisional application No. 62/562,910, filed on Sep. 25, 2017.

(51) Int. Cl. G06F 16/901; G06F 16/908; G06F 16/31; G06Q 10/06

(52) U.S. Cl. CPC G06F 16/9024; G06Q 10/067; G06F 16/322; G06F 16/908

(57) ABSTRACT

The present disclosure relates to systems and methods of autonomously or semi-autonomously generating a graph based upon ingested data, triggered by a user or a machine driven request, including for organizations that do not possess a fully ingested/inflated graph. Nodes of a graph may comprise expressions tied to specific data and/or data fields of the organization. Dimensional hierarchies may also be mapped to the specific data and/or data fields. Also disclosed are systems and methods for extrapolating and inflating ingested data and providing analysis to a user. The present disclosure also: (1) provides autonomous (or semi-autonomous) ingestion of data and inflation of a graph across potentially billions of nodes attributable to a particular organization; (2) retrieving insights and analysis on demand at various levels of detail; and (3) permits system resources to identify and analyze patterns, trends and anomalies in the graph for making adjustments and enhancements.

### CROSS-REFERENCE TO RELATED APPLICATIONS

This application claims priority to and the benefit under 35 U.S.C. § 119(e) to U.S. Provisional Patent Application Ser. No. 62/834,298, filed Apr. 15, 2019, and is a continuation-in-part of U.S. patent application Ser. No. 16/141,751, filed Sep. 25, 2018, which in turn claims priority to U.S. Provisional Patent Application Ser. Nos. 62/625,645 filed on Feb. 2, 2018 and 62/562,910, filed on Sep. 25, 2017. Each of these patent applications is incorporated by reference herein in its entirety.

### FIELD OF THE INVENTION

The present invention is generally directed toward systems and methods for receiving and analyzing data, and more specifically to systems and methods for autonomously ingesting, inflating, analyzing, processing and supplying information in response to an inquiry, instruction or command.

### COPYRIGHT NOTICE

A portion of this disclosure is subject to copyright protection. Limited permission is granted to facsimile reproduction of the patent document or patent disclosure as it appears in the U.S. Patent and Trademark Office (USPTO) patent file or records. The copyright owner reserves all other copyright rights whatsoever.

### BACKGROUND OF THE INVENTION

Business and finance-related systems contain information in a variety of different manners, and increasingly contain a quantity of data that makes it difficult, if not impossible, for an individual (or multiple individuals) to quickly retrieve and analyze. Such information may be derived from a source document or from several sources of data, updated on a daily, weekly or monthly basis, and in some instances may be updated constantly or involve streaming data. This information may be organized according to one or more formats or systems, further complicating the retrieval and analysis of such information.

Large data sets concerning financial and/or business intelligence are increasingly being reviewed and modified, often by numerous individuals across multiple divisions, departments and organizations, causing further difficulties. Current business analytical approaches are often highly customized for the data source and structure being analyzed. Accordingly, current analysts treat these data sets as largely immutable, and therefore adapt a broad variety of analytical techniques to suit the business task at hand. This creates discrepancies between one analytical approach and another, which in turn can create discrepancies when attempting to merge the analysis performed by one analyst with another, particularly where the analysts have different respective objectives.

Current state of the art business intelligence systems provide a lot of data to users, but such systems have limited or no intelligence to perform analytical tasks. At most, such systems comprise stand-alone, predictive analytic capabilities typically used for scoring (lead scoring, retention scoring, credit scoring, propensity modeling, in some cases media attribution), or broad pattern recognition (network breach detection, network security analysis). Prior art systems are typically devoid of pertinent domain knowledge, which is required to perform meaningful root cause analysis and/or performance assessment. These systems are also complex, reactive, and require significantly more resources to operate. Further, these systems are hard to scale, particularly when overwhelmed with data, as those of skill with Hadoop systems are familiar.

Outside of business intelligence systems, certain applications exist that can provide assistance with general tasks, such as setting reminders or navigating through a metropolitan area. However, such applications are generally limited in the number of voice commands and simple queries those applications are able to interpret, and do not engage in ongoing dialog or maintain context over time. Prior art applications also require significant training to understand a user's commands and maintain the context necessary to engage in bidirectional or other complex communications with a human user or fail to provide meaningful analysis and processing of data in the manner equivalent to a business or financial analyst. Further, there are a number of shortcomings in the art with respect to a user's ability to access and analyze such information quickly and efficiently, so that information necessary to make business or financial-related decisions is possible in real (or near real) time.

Furthermore, current systems and methods for providing business insights are time consuming and inefficient, including insights provided in the form of memos, presentations, dashboards, charts, etc. For example, key performance indicators (KPI) in present displays are often hard to use, especially when incorporating large amounts of data. As a result, current business and financial analysts are forced to manually browse charts and reports containing up to hundreds of thousands of data points, while simultaneously attempting to derive meaning from and discern the relationships among those data points. While attempts have been made to display large amounts of data (including business and financial data) to a user, such prior art displays suffer from numerous disadvantages. Those disadvantages include requiring a user to manually define and manage a large number of data points, lack of automation in creating the display, inability to recognize anomalies or determine root causes, lack of dimensional and cross-dimensional relationships between data points, difficulties in managing scale and density of the data represented in the display, and other shortcomings. Many of these systems cannot ingest all the data the user wants to ingest or analyze, and/or the number of dimensions in the dataset quickly overwhelms the prior art system's ingestion process.

It would therefore be beneficial to provide an autonomous, virtual agent or analyst that is capable of and configured to provide intelligent, analytical processing of information contained in one or more business intelligence systems, and which otherwise can provide the needed business intelligence in an efficient and timely manner. It would also be beneficial to display data and analysis in a graphical format that is autonomously or semi-autonomously generated and solves the shortcomings of prior art displays outlined above. Further, it would be extremely beneficial to provide a user with a system and method for dynamically inflating a driver graph for a particular metric(s) via an automated or semi-automated process to provide real-time analysis of the business metric(s) and facilitate other objectives described in more detail herein.

It is with respect to the above issues and other problems presently faced by those of skill in the pertinent art that the embodiments presented herein were contemplated.

### SUMMARY OF THE INVENTION

The present disclosure relates to systems and methods that overcome the problems identified above. While several advantages of the system and method of one embodiment are provided in this section, this Summary is neither intended nor should it be construed as being representative of the full extent and scope of the present invention. The present invention is set forth in various levels of detail in the Summary as well as in the attached drawings and in the Detailed Description, and no limitation as to the scope of this disclosure is intended by either the inclusion or non-inclusion of elements, components, etc. in the Summary. Additional aspects of the present disclosure will become more readily apparent from the detailed description.

The systems and methods described herein are, according to preferred embodiments, optimized for streamlining and automating one or more analytical tasks, such as: (1) anomaly detection, (2) correlation and/or clustering, (3) forecasting, and (4) structure learning. According to alternate embodiments, additional analytical tasks are disclosed for use with the systems and methods described herein.

The foregoing systems and methods preferably comprise a system or subsystem referred to herein in varying embodiments as a “driver graph.” The driver graph preferably captures and presents a normally complex and interwoven series of “nodes” into an easily readable and navigable graphical representation. The incorporation of driver graphs, and the autonomous and semi-autonomous virtual analysts described below, removes a significant resource burden from business and financial analysts, among other analysts. For instance, the use of the novel driver graph topology described herein removes the time-consuming task of customizing business and/or financial analytics, and permits an analyst to focus on manipulating, interpreting or updating the driver graph. The amount of data that can be analyzed is also greatly increased through the use of well-designed interfaces. Furthermore, the creation of a driver graph may be largely or completely autonomous, thereby permitting users to create, ingest data for and inflate driver graphs for data sets that are far too large or complex to build manually.

According to one aspect of the present disclosure, systems and methods described in detail herein provide a user with autonomous virtual analyst(s) or module(s) (“analytical modules”) capable of completing a variety of tasks upon receiving an inquiry, instruction or command from a user. In embodiments, the analytical module may substitute for or otherwise provide the equivalent functions of a financial or business analyst, with the capabilities to interpret, analyze, compare, contrast, extrapolate, project or otherwise process information to provide the user with valuable business intelligence in a convenient, useable format.

According to another aspect, systems and methods are described for automatically initiating and conducting business or financial analysis, or to make, track and approve modifications to that analysis, reconcile those modifications, and ultimately approve and/or finalize that analysis through the use of one or more analytical modules. In embodiments, the business or financial analysis data set may be accessed several times by several different individual users and may involve a plurality of analytical modules.

It is yet another aspect to provide a user with an efficient way to obtain business intelligence with respect to data contained in one or more data repositories and modify the business intelligence through creation of one or more reports. By analyzing a larger set of data sources and combining them in a novel manner, and particularly when employed in combination with one or more driver graphs, the systems and methods described herein are configured to point out data relationships to the analyst that may inform the analyst's own work and downstream analysis, further enabling the analyst to adapt or modify the system to get to better, more relevant and more timely insights to other users in the business.

In yet another aspect, the system and methods described herein comprise a convenient, integrated interface or display for a user to view the status or performance of one or more metrics. In certain embodiments, the interface may also comprise an automated assessment and/or proof-points or other insights, which are displayed in an efficient and easy to understand manner. The interface(s) further provide the user with the option of automatically generating a business presentation with said insights in a fraction of the time it takes to complete such tasks manually.

In yet a further aspect of the present disclosure, a computer readable storage medium comprising processor executable instructions operable to utilize the system or perform the methods is provided. In one aspect, the present disclosure relates to a system for autonomously organizing and analyzing data associated with an organization, comprising a source of transactional data, that preferably comprises temporal, geographical and other types of metadata about a plurality of transactions, the source data acquired by way of flat files, databases internal to the organization or third-party databases, a processor operating on specially configured computational machinery, wherein the processor is programmed to retrieve and validate structured data from the data source, transform the data into a graphical format to comport with a predetermined dataset format, construct and store in a data storage medium a directed primary graph that comprises a plurality of Primary Nodes and Dimension Nodes configured to represent one or more relationships between organizational business metrics, wherein each Primary Node contains a unique identifier that is used by the inflation function below to generate the driver graph, construct and store in the data storage medium, hierarchical trees for one or more business dimension, wherein each Dimension Node contains a unique identifier that is used by an inflation function to generate the driver graph, and a driver graph generation module comprising a driver graph node indexer that determines the combination of unique Primary Nodes and unique Dimension Nodes for modeling transactional data processing into a Primary Driver Graph, a mapping function, wherein the mapping function aggregates the transactional data based on the unique set of Primary Node and Dimension Nodes determined by the driver graph node indexer, a business metric relationship function used by the mapping function to correctly aggregate the transactional data based on the business metrics' relationships as stored within the Primary Driver Graph, an inflation node function, wherein each combination of the unique set of Primary Nodes and Dimension Nodes is generated as a product of the Primary Driver Graph and each Dimension Graph, and wherein each combination is then used to transform the transactional business data, using the driver graph node indexer, the mapping function, and the business metric relationship function, into a Driver Graph Node, an inflation edge function, wherein all Driver Graph Nodes are then connected by Driver Graph Edges that are the result of the cartesian product of the Primary Graph and each Dimension Graph, and a storing function, wherein in-memory node and edge data are translated and stored in the data storage medium.

It is to be expressly understood that the ensuing description provides embodiments only, and is not intended to limit the scope, applicability, or configuration of the claimed invention. Rather, the ensuing description will provide those skilled in the art with an enabling description for implementing the embodiments. It should be understood that various changes may be made in the function and arrangement of elements without departing from the spirit and scope of the appended claims.

Furthermore, while embodiments of the present disclosure will be described in connection with various examples of business intelligence data and information, it should be appreciated that embodiments of the present disclosure are not so limited. In particular, embodiments of the present disclosure may be applied to a variety of information and/or data sources. For instance, while embodiments of the present invention may be described with respect to finance-related inquiries, other applicability is contemplated.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. Unless otherwise indicated, numbers expressing quantities, dimensions, conditions, and so forth used in the specification and claims are to be understood as being approximations which may be modified in all instances as required for implementing the systems or methods described herein. It is also to be noted that the terms “comprising”, “including”, and “having” and variations thereof is meant to encompass the items listed thereafter and equivalents thereof, as well as additional items, and may be used interchangeably.

The terms “automated”, “automatically”, “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “machine-readable media” or “computer-readable media” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a flexible disk, hard disk, magnetic tape, or any other magnetic medium, magneto-optical medium, a CD-ROM, any other optical medium, a RAM, a PROM, an EPROM, a FLASH-EPROM, a solid state medium like a memory card, any other memory chip or cartridge, or any other medium from which a computer or like machine can read.

When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The term “database”, “data source” or “data repository” as used herein refers to any one or more of a device, media, component, portion of a component, collection of components, and/or other structure capable of storing data accessible to a processor. Examples of data sources contemplated by this definition include, but are not limited to, processor registers, on-chip storage, on-board storage, hard drives, solid-state devices, fixed media devices, removable media devices, logically attached storage, networked storage, distributed local and/or remote storage (e.g., server farms, “cloud” storage, etc.), media (e.g., solid-state, optical, magnetic, etc.), and/or combinations thereof.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, machine engine, artificial intelligence, fuzzy logic, or combination of hardware and software that is capable of performing the functionality associated with that element.

While the invention is described in terms of exemplary embodiments, it should be appreciated that individual aspects of the invention may be separately claimed.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosure. Similar components, elements and/or features may have the same reference number, and components of the same type may be distinguished by a letter following the reference number. If only the reference number is used, the description is applicable to any one of the similar components, elements and/or features having the same reference number.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein. In the drawings:

FIG. 1 illustrates a system architecture and various elements of the systems and methods described herein in accordance with embodiments of the present disclosure;

FIG. 2 is a schematic diagram illustrating a driver graph ingestion and inflation in accordance with embodiments of the present disclosure;

FIG. 3A illustrates an exemplary topology for a driver graph in accordance with embodiments of the present disclosure;

FIG. 3B illustrates various categories and subcategories of analytics to be performed by the systems and methods in accordance with embodiments of the present disclosure;

FIG. 3C illustrates exemplary business and financial analytics capable of being performed by the systems and methods described herein in accordance with embodiments of the present disclosure;

FIG. 4A illustrates one taxonomy for a driver graph and an exemplary arrangement of nodes in accordance with embodiments of the present disclosure;

FIG. 4B illustrates the node-link relationships in accordance with the embodiment shown in FIG. 4A; and

FIG. 5 illustrates another schematic diagram illustrating dynamic inflation of a graph in accordance with embodiments of the present disclosure.

### DETAILED DESCRIPTION

The present disclosure has significant benefits across a broad spectrum of applications and endeavors. It is the Applicant's intent that this specification, and the claims appended hereto, be accorded a breadth in keeping with the scope and spirit of the disclosure and various embodiments disclosed, despite what might appear to be limiting language imposed by specific examples disclosed in any one or several embodiments. To acquaint persons skilled in the pertinent arts most closely related to the present disclosure, preferred and/or exemplary embodiments are described in detail without attempting to describe all of the various forms and modifications in which the novel systems and methods might be embodied. As such, the embodiments described herein are illustrative, and as will become apparent to those skilled in the arts, may be modified in numerous ways within the spirit of the disclosure.

In embodiments, the systems and methods disclosed herein provide information to a user in an automated or semi-automated manner. In one embodiment, the systems and methods provide analysis and business intelligence relating to revenue, income, profit, loss, expenses, historical data, projections, trends, comparative analysis, etc.

Methods of automatically and near-instantaneously (i.e., near real-time) providing information in response to a user inquiry are also disclosed herein. In other embodiments, the system and methods comprise one or more analytical module(s), which may be configured to be adaptive and provide new functions/processes or acquire additional knowledge through the course of interactions with a user. In yet other embodiments, several analytical modules may be provided with distinct or partially overlapping capabilities, and in certain embodiments are configured to communicate and interact with one another to more efficiently process requests from the user(s) and provide information relevant to the user(s) request.

In embodiments, the analytical module(s) may further comprise the capability to supply the user with specific reports, graphs, analysis and insights in a predetermined or independent manner. In other embodiments, analytical module(s) may be configured to automatically determine the appropriate reporting and analysis to supply to the user in response to an inquiry, instruction or command, including through the use of driver graph logic described in greater detail below. In still other embodiments, the analytical module(s) possesses the capability to engage in natural language dialog with one or more users and receive and understand various inquiries, instructions and commands. In varying embodiments, the system may entail context-based dialog with a user.

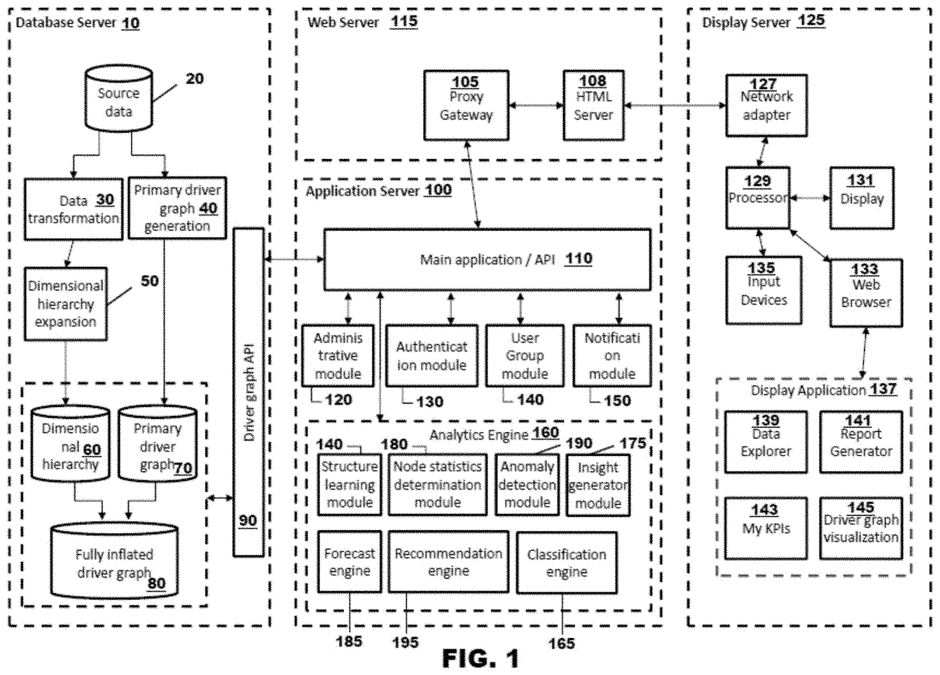

Various aspects of the systems and methods according to embodiments of the present disclosure are depicted in FIGS. 1-5. It should be understood that the drawings are not necessarily to scale, and in certain instances, details that are not necessary for an understanding of the disclosure or that render other details difficult to perceive may have been omitted. Also, certain details may be depicted in certain drawings while omitted in other drawings, but it is to be understood this is done for the purpose of streamlining the disclosure. Accordingly, components and elements shown in certain drawings may be included in other drawings or embodiments despite those components/elements not being explicitly shown in each individual drawing figure.

Various elements of the system according to embodiments of the present disclosure are shown in FIG. 1. Several elements may be grouped in a database server 10, as reflected in FIG. 1. However, it is to be expressly understood that these elements may reside on separate servers or locations, including in the absence of a traditional server. In embodiments, the system comprises source data 20, which may represent data provided by or associated with a business or organization. The source data 20 may comprise third party data and may include structured and unstructured data. The systems and methods described herein preferably comprise a Data Transformation 30 module or step, as shown in FIG. 1. In embodiments, Data Transformation 30 is necessary and/or useful for later aggregation of data, efficient processing of data, and during the driver graph inflation process described in detail below. In certain embodiments, Data Transformation 30 is automated or semi-automated and may be made on demand by a user or a machine. In other embodiments, a portion of the Data Transformation 30 occurs through manual processes. Combination of these embodiments is contemplated for purposes of the present disclosure.

To further illustrate Data Transformation 30, reference is made to Table 1 below:

Table 1 displays data arranged in a dataset following Data Transformation 30 according to certain embodiments. In preferred embodiments, the dataset comprises a unique identifier (uid), which may be used to trace any individual line of data within the dataset. The dataset also preferably comprises a period field, which in Table 1 represents the month and year associated with each row of data in the dataset. Multiple dimensions (dimension1, dimension2 and dimension3) may also be included with the dataset and reflect multiple variable, such as market1, market2, product1, product2 and segment in Table 1. As shown, certain dimensions may comprise multiple dimensional levels (i.e., market and product), while other dimensions may comprise only a single level (i.e., segment). However, any combination and number of dimensions may be included in a dataset, regardless of whether they are multi-dimensional or singular. Table 1 also depicts the individual metrics, such as revenue and sales units. Metrics are important to the Data Transformation 30 process because they represent important business or organizational values and, once mapped, may be aggregated, associated with or compared to other metrics. The systems and methods described herein also permit visually representing individual and aggregate metrics despite the typically large quantities of data obtained from the Source Data 20. By completing the Data Transformation 30 and formatting the datasets in this manner, individual or aggregated metrics may be queried, polled, sorted, filtered, manipulated and displayed in a meaningful manner, regardless of quantity, through the systems and methods described in detail herein.

In certain embodiments, Source Data 20 cannot be aggregated into a single dataset. This can occur where, for example, the Source Data 20 is extracted for different periods. To expand on this example, when one dataset is aggregated at a monthly frequency, and another is on a quarterly or yearly frequency, it may require the datasets to be loaded separately. Alternatively, one dataset may include a different set of dimensions than another. For example, sales data may include one or more “channel” dimensions, but inventory data does not.

The underlying data in the datasets may be aggregated at different and incompatible “grains”. For example, certain data correlating to a place of lodging may be stored at the “stay” grain such that all metrics (revenue, customer count, etc.) apply at a “per stay” grain, while another dataset, such as the general ledger, might aggregate the same data on a daily or weekly basis. In such cases, the aggregates of metrics will not match because the source periods, dimensional hierarchies and grains do not match across datasets. As a result, it is useful to allow multiple datasets to define different metrics that can co-exist in the same data graph structures.

In the example where periods differ, if one period can be mapped to another (e.g., daily to monthly periods), the dataset may be consolidated at the coarsest level (monthly) and treated as a single dataset. Conversely, if the periods cannot be matched (week-of-year vs month), then the two datasets can still be loaded across the same level of nodes while still being treated independently (i.e., each with its own set of periods and measures). These datasets may alternatively be aggregated at a longer, common time period (such as a year).

For datasets with differing dimensions, those datasets may still be made congruent so long as the dimensional values are at least partially consistent across all datasets (i.e., at least partially overlap). For example, if dataset A includes market and channel dimensions, and dataset B has market and product dimensions, those metrics may be combined within the same driver graphs (so long as the overlapping dimension has consistent values across the datasets).

When the “grains” are different, aggregation is difficult to achieve in a consistent way across the datasets. However, as long as the period and dimensions are aligned, the Data Transformation may use different measures for each of the grains. In the lodging example, this could result in different measures such as stay_revenue and stay_length for stay-related “grain” data, and daily_revenue and daily_room_rev for day-related “grain” data. While these measures do not match, Data Transformation 30 may store the grain data in a common nodal level as long as the dimensions and reporting periods are consistent across the datasets.

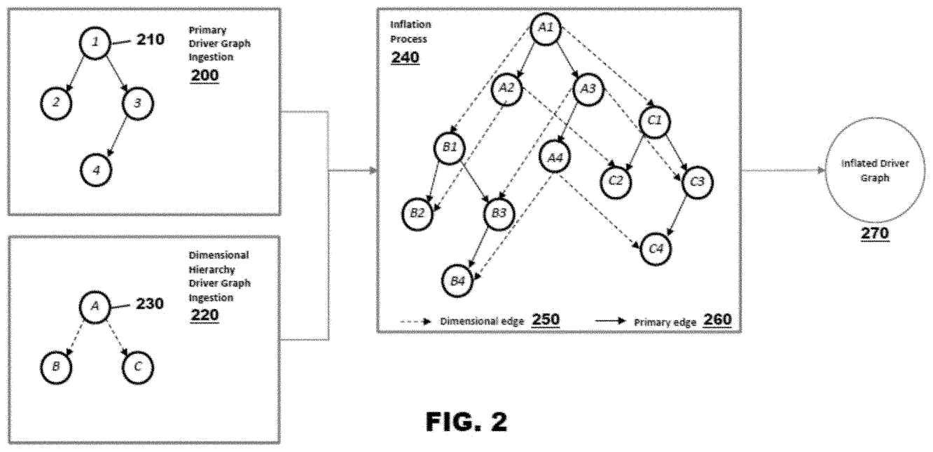

Various aspects of the present disclosure relate to the creation and function of a Primary Driver Graph 70 and Fully Inflated Driver Graph 80. As described in more detail in relation to FIG. 2, the systems and methods further comprise a Primary Driver Graph Generation 200 module or step. According to embodiments, the Primary Driver Graph 70 refers to a set of business measures, outcomes or metrics, and their respective relationships with each other, preferably without consideration of the different dimensions of the business (including by way of example but not limitation, product(s), market(s), revenue, costs, distribution channel(s), customer segment(s), administrative unit(s), etc.) The Primary Driver Graph 70 is formulated via the Primary Driver Graph Generation 200 module, preferably incorporating metrics derived from the source data. Thus, according to embodiments, the Primary Driver Graph 70 is based on an organization's metrics and fundamentally defines how those metrics, which in turn capture the performance of a business or other organization, relate to each other. Once generated, the Primary Driver Graph 70 is preferably stored in a driver graph database, as shown in FIG. 1.

A typical Primary Driver Graph 70 may include hundreds of nodes 210, and while generating a fairly simple driver graph by an individual is possible, it is a long and arduous process, subject to error. According to the systems and methods described herein, the Primary Graph Generation 200 process automates (or in some embodiments, semi-automates) the generation of the Primary Driver Graph 70 to autonomously or semi-autonomously and efficiently produce a Primary Driver Graph 70 for a set of metrics. As described in greater detail herein, the Primary Driver Graph Generation 200 module or step preferably identifies and assigns links among nodes in the Primary Driver Graph 70, including those that a human user would have difficulty identifying.

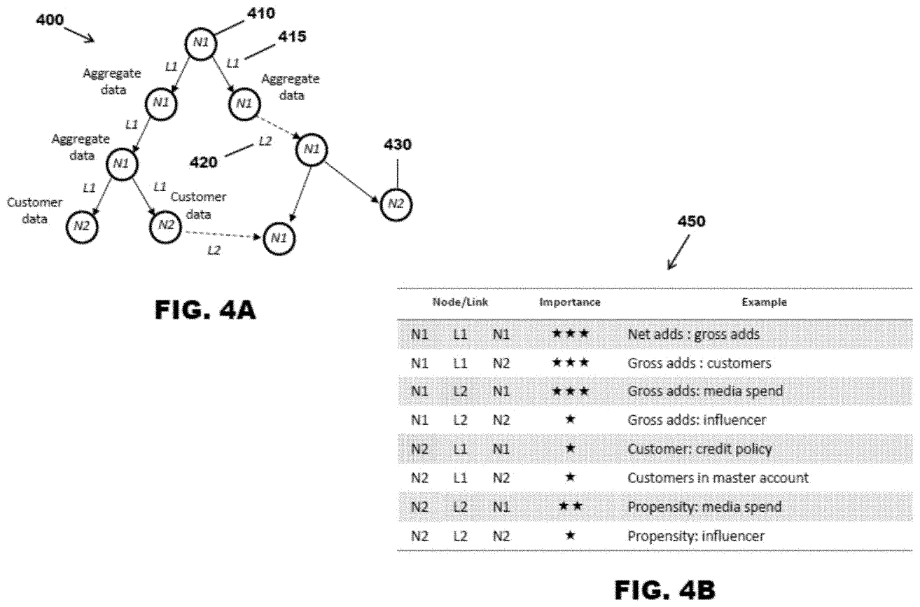

Another aspect of the present disclosure relates to a Dimensional Hierarchy 60 module or process. In most embodiments, the systems and methods further comprise a Dimensional Hierarchy Expansion 220 module or step, which comprises the processing of structured data received from the Source Data 20, following the Data Transformation 30, to generate a structure of “nodes” and “edges” that comports with the hierarchy of the organization's data. The Dimensional Hierarchy Expansion 200 associates metrics with nodes, at appropriate levels within the hierarchy, so that the system can efficiently aggregate those metrics across all nodes in the Primary Driver Graph 70 and, eventually, an inflated Driver Graph 80 (as described in greater detail below). In the Figures, nodes are visually represented as circles on the Primary Driver Graph, whereas relationships between nodes (also referred to herein as links or edges) are visually represented by lines between two or more nodes. In certain drawing figures, such as FIG. 2, solid lines between nodes represent primary links or edges, whereas dashed lines represent dimensional edges. In these figures, the dimensional edge between nodes is derived from the Dimensional Hierarchy Expansion 200 module and Primary Driver Graph. In yet other figures, such as FIG. 4A, the solid lines (L1) represent deterministic links, while the dashed lines represent probabilistic links.

Once compiled, the Dimensional Hierarchy 60 is stored in a Dimensional Hierarchy Database (DHDB) and comprises the hierarchical representation of the organizations various dimensions. These dimensions and associated metrics may be maintained with the DHDB in a graphical format, such as a Primary Driver Graph 70. The Primary Driver Graph 70 may be understood as a basic set of nodes and inter-nodal relationships that correlate to other nodes and nodal relationships associated with the organization, and which serve to define the metrics of the organization are attributable to primary nodes.

Referring to FIG. 2, the systems and methods described herein may also comprise a Driver Graph Inflation 240 process. The Driver Graph Inflation 240 process is necessary for most businesses and other organizations because the Primary Driver Graph 70 alone is not sufficient to generate business insights, in part because the Primary Driver Graph 70 does not possess any dimensional information for any of the metrics. Incorporating an organization's dimensional information will typically multiply the size of the Primary Driver Graph 70 by a factor of 1,000 to 10,000 or more. Thus, while generating even a simple Primary Driver Graph 70 is considered extremely difficult to achieve manually, the generation of a complete or inflated Driver Graph 80 is outright impossible for a human to handle. According to embodiments, the analytical module described above is configured to implement the Driver Graph Inflation 240 process to augment the Primary Driver Graph 70 with dimensional information. This process is preferably highly (if not completely) automated and allows the system to generate a full driver graph necessary to produce insights.

During Driver Graph Inflation 240, the Dimensional Hierarchy 60 and Primary Driver Graph 70 may be relied upon to expand or inflate the node and nodal relationship data and incorporate the same into other driver graphs as shown in FIG. 2. For example, by combining metrics from the Primary Driver Graph 70, and the dimensional data from the DHDB, additional primary and secondary (also referred to as parent and child) nodes may be extrapolated. Thus, primary interrelationships 260 (represented by solid arrows in FIG. 2) that have already been determined as to primary nodes A1-A4 can be inflated to nodes B1-B4 and C1-C4. Similarly, dimensional relationships 250 (represented by dashed arrows in FIG. 2) can be inflated from node A1 to B1 and B2, or A4 to B4 and C4, for example. As additional nodes 210 are identified, the analytical module may assign previously determined relationships between the one or more additional nodes. The relationships may be sophisticated and evolve into hierarchies, which may follow established or ad hoc rules or methodologies. In some embodiments, the user may establish new rules and/or methodologies as orphan nodes are uncovered. In other embodiments, the analytical module is able to recognize the different interrelationships between the one or more nodes and establish rules and/or methodologies without assistance of the user. In yet other embodiments, the user is given the opportunity to review and revise the rules and/or methodologies derived by the analytical module.

During Driver Graph Inflation 240, node statistics and relationships may be evaluated and tested against the Primary Driver Graph 70 and dimensions of the DHDB. For example, once inflation has occurred along primary and dimensional lines, the system may be configured to determine node statistics such as z-score, deviation, last value, mean, etc. The system may also be configured to determine the contribution from a child node to a parent node, or their respective values and/or variances. This information in turn may be used to test or evaluate the correctness of the Driver Graph Inflation.

Referring to FIGS. 1 and 2, the inflation may result in a Fully Inflated Driver Graph 270. The Fully Inflated Driver Graph 270 may be stored with the DHDB and Primary Driver Graph 70, and may be configured to communicate with an Application Server 100 via a Driver Graph API 90. The Fully Inflated Driver Graph 270 may be updated and modified as new Source Data 20 is received or new Dimensional Hierarchies 60 are defined. Although not shown in FIG. 1, embodiments may further comprise at least one data repository, such as a financial data repository, a sales data repository, a customer-relationship-management data repository, a business-specific data repository, and a remotely connected third-party data repository. The data repository may also store a set of user preferences and one or more sets of user data.

In embodiments, the system may comprise one or more applications, which may be in communication with analytical modules through one or several other discrete modules. In one embodiment, the application is designed to operate on a mobile device or mobile computer and assist a user with managing data and providing organization among the analytical modules. In one embodiment, the application/modules are configured to access one or more datasets, tables or databases, including one or more relational databases. In one embodiment, the application includes time and/or content-specific notifications. In embodiments, the application/modules further permit a user to sort, search and modify documents and manipulate data associated therewith, in many instances automatically.

Referring again to FIG. 1, the Application Server 100 comprises computational machinery specifically and/or computer-readable media configured for performing various aspects of the systems and methods described herein. The Application Server 100 preferably comprises the main application and associated API 110. In one embodiment, the main application/API 110 is derived from a web application framework, such as Django. The main application 110 is preferably in direct communication with the Driver Graph 70 and Dimensional Hierarchy Database 60, via the Driver Graph API 90, to read, write and process driver-related information and application data. The main application 110 is also preferably configured to communicate with other modules, including but not limited to an Administrative Module 120, an Authentication Module 130, a User Group Module 140 and a Notification Module 150. The main application 110 is also in communication with the Analytics Engine 160 described in greater detail below.

The Application Server 100 may also be in communication with a Web Server 115 as shown in FIG. 1. The Web Server 115 preferably comprises a Gateway 105 and HTML Server 108, which in turn communicates and conveys information from the Application Server 100 to the Display Server 125. The Display Server 125 may comprise a processor 129, network adapter 127, web browser 133 and other elements 131, 135 that will be readily understood by one of ordinary skill in the art. The Display Server 125 also preferably comprises a Display Application 137 and associated Report Generator 141, Data Explorer 139, Driver Graph Visualization 145 module and other modules 143 described herein.

Returning to the description of the Primary and Fully Inflated Driver Graph 270, in certain embodiments the analytical module may adapt the graph and/or mapping autonomously, thereby transforming the Driver Graph into a predictive and proactive tool for an enterprise. For example, using the adaptive learning and other capabilities described herein, the analytical module may develop the ability to predict where root causes of enterprise performance issues originate, and potentially alert the user before the issue elevates to a potential anomaly or anomaly. In other embodiments, the analytical module may evolve a module to improve upon the model or map of the enterprise and make suggestions to the user of ways in which the nodes can be redefined, and thereby adapt its analytical and forecasting capabilities in a non-stationary environment. For instance, if the analytical module identifies a change in the enterprise environment, such as a change in the database environment, a change in market structure, in product hierarchy, or in competitive dynamics (for example), the analytical module will adapt to reallocate connections and/or resources to continue functioning optimally in the new environment in spite of said changes. However, in lieu of or in addition to the remediation features of the analytical module, the module may further suggest a remodeling of the node cluster and the underlying operating resources to alleviate the operating impact and related issues of the changes in the enterprise environment. Thus, an enterprise may learn new ways of structuring its various nodes and removing unhealthy interdependencies through use of the analytical module and Primary Driver Graph module.

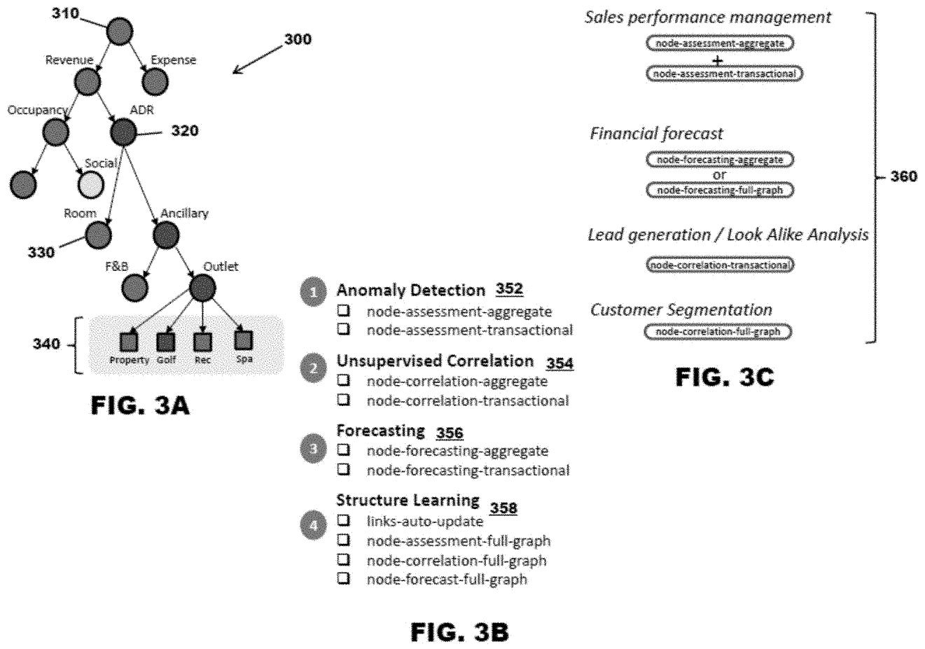

Additional aspects relating to the Driver Graph and various nodal relationships disclosed herein are shown in connection with FIGS. 3A-4B. For many organizations, the number of discrete “nodes” is so large that it is difficult, if not impossible, to graphically present those nodes in a logical manner. Even when focusing on specific business applications, a graph or equivalent display often includes anywhere from a dozen to hundreds of thousands of nodes. Manually creating and maintaining such a graph is impossible, particularly when the nodes in the graph require periodic modification or have dynamic relationships with other nodes that need to be assessed and, in many cases, reevaluated.

Referring specifically to FIG. 3A, nodes 310, 320, 330 are preferably displayed showing their connections (i.e., relationships) to other nodes in the system. In some instances, multiple nodes may be connected to the same node. Certain nodes may appear in the interface to represent a parent-child relationship, whereas other nodes may be more appropriately classified as peers. In some embodiments, a parent node 310 may be graphically represented in a manner differently than a child node 330, such as by appearing larger than the affiliated child node. In this same embodiment, peer nodes may be sized or shaped or colored the same to indicate those nodes are peers. Variations on the embodiments described and depicted in this disclosure are contemplated.

The visual representation associated with the driver graph, such as the one shown in FIG. 3A, further enhance the user's ability to understand anomalies in the data set associated with the driver graph. For example, when a metric and its associated node in the driver graph is found the be anomalous, an associated display provides a visual clue or indicia to call the anomaly to the attention of the user. As yet another example, the display may further provide a summary of automatically generated insights derived from the anomalies detected. These aspects of the system are elaborated on in more detail below.

Referring now to FIG. 3B, once the Fully Inflated Driver Graph has been stored, the system may comprise numerous analytics to a user. These analytics may comprise Anomaly Detection 352, for example through node assessment (in the aggregate or on a transactional scale). Other analytics may consist of Forecasting 356, Structure Learning 358 and Unsupervised Correlation 354. Each of these is described in greater detail below. Business and/or organizational application of these various analytical tasks 360 are represented in FIG. 3C.

To better illustrate the aforementioned analytics, it is important to note that each Driver Graph is preferably configured to be responsive to system anomalies and other events to provide dynamic insights to a user. Once the system detects anomalies with the performance or state of specific nodes, the Driver Graph is configured to determine the root cause of such anomalies to generate a useful business insight. Anomaly Path Generation and Detection or APGD, as referred to herein, is a heuristic approach applied to all node anomalies. It is equivalent to a triage process for identifying potential and/or likely root causes. Root cause analysis inherently raises the question of what a root cause is. While the notion of proximate cause is easily defined, that of ultimate (or root) cause is much more elusive. APGD handles this problem of root cause identification efficiently by determining and evaluating a weighted score for detected anomalies and, in certain embodiments, their distance (in the graph) from the metric or node being assessed.

While APGD is efficient and practical in handling a large volume of data, it may not be optimal due to its heuristic nature. Root Cause Focusing (RCF) provides a more optimally defined solution to the problem of root cause identification by looking at anomaly causes at various distances from the node of interest. In preferred embodiments, RCF builds a series of Pareto curves and identifies the curve or layer that provides the most contrast or the best-defined feature explaining the anomaly at the node of interest.

FIGS. 4A-4B illustrate a taxonomy for the driver graph and various node-link relationships in greater detail. In FIG. 4A, a Driver Graph is shown comprising either types of node/link relationships, wherein node N1 consists of aggregate level data. The node/link relationships are further illustrated in FIG. 4B. For example, the N1-L1-N1 node/link relationship comprises a net adds to gross adds relationship, whereas the N1-L1-N2 node/link relationship comprises a gross adds to customers relationship. As shown in FIG. 4B, certain node/link relationships may be scored or weighted with greater importance to an organization than others.

In embodiments, the system and method may be configured to establish a hierarchy between classifications of business or financial information and thereby perform more sophisticated pattern and comparative analysis. In embodiments, the system may be configured to interpret the DHDB and establish one or more new hierarchies based upon the information in the database. The system and method may further comprise a machine learning module for adapting to new data and making conclusions regarding the classification or hierarchies to which the new data belongs. In other embodiments, the system and method may comprise a training module for user-driven learning of the differences between different data sets and associations that may be drawn by the analytical module for analyzing the same.

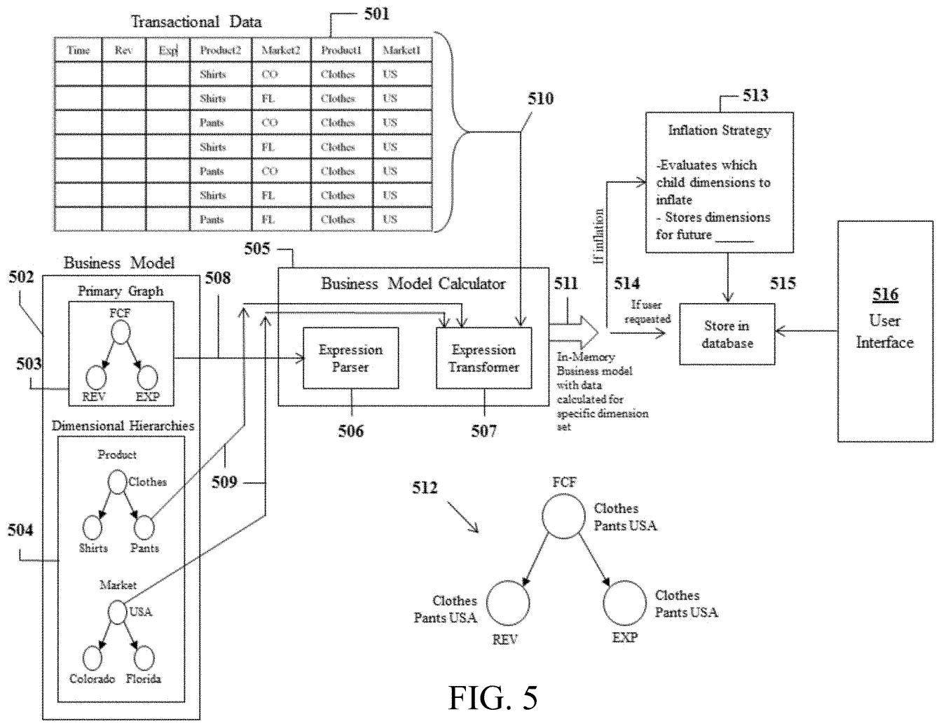

Referring now to FIG. 5, another embodiment is shown. According to this embodiment, a graph may be generated by the systems and methods autonomously or semi-autonomously by a user or a machine-driven request, including for organizations that have not previously computed a fully ingested/inflated graph. The system and method according to this embodiment performs this function in part by the nodes further comprising expressions tied to specific data and/or data fields contained in the transactional data for the organization, and in part by mapping dimensional hierarchies to the specific data and/or data fields, which in turn permits the system and method to extrapolate the data and provide analysis to a user relating to the specific data and/or data fields. This embodiment, which is described in greater detail below, provides two key benefits to a user: (1) by providing a system and method for immediate and autonomous (or semi-autonomous) ingestion of data and inflation of the graph across the potential billions of nodes attributable to a particular organization, and retrieve insights and analysis on demand at any level of detail; and (2) by permitting system resources to identify and analyze patterns, trends and anomalies in the graph, including but not limited to business relationship metrics, and correspondingly make adjustments and enhancements to the graph. The system and method may be optimized for analytical and modeling capabilities, while eliminating the need for pre-computational analysis of data in batch or aggregated fashion. More particularly, when analyzing larger sets of data, the systems and methods of this embodiment may be better configured to point out data relationships and inform downstream analysis, further enabling a user or a machine to adapt or modify the system to get to better, more relevant and more timely insights than previously experienced.

Referring in detail to FIG. 5, the system and method may utilize an organization's transactional or other datasets 501. The organization's datasets 501 may comprise third party data and may further include structured and unstructured data. The datasets 501 may comprise a period or time field, which may represent the day, week, month and year associated with each row of data in the dataset. In preferred embodiments, one or more dimensions are included with the dataset, such as market1, market2, product2 and product2. Certain datasets 501 may comprise multiple dimensional levels (i.e., market and product), while other dimensions may comprise only a single level, although any combination and number of dimensions may be included in a dataset 501. The dataset 501 may also comprise specific metrics, such as revenue (Rev) and expenses (Exp), as reflected in FIG. 5.

The transactional or other data residing in the datasets 501 is preferably stored in one or more relational database(s). The specific data fields in the datasets 501 may be referenced during an autonomous inflation process, as described in greater detail below. The data may be useful to one or more business models 502. The business model 502, as described in the embodiments above and in related U.S. patent application Ser. No. 16/141,751 incorporated herein by reference, is preferably comprised of a Primary Graph 503 and a Dimensional Hierarchy 504. However, unlike the previously described embodiments, the specific nodes of the graphs associated with one or more business models 502 may comprise expressions for determining the specific transactional data to extrapolate upon, and the Dimensional Hierarchies 504 may be mapped to specific data fields within the datasets 501, as described more fully in the following paragraphs.

Here, each node may comprise an expression that defines how to process specific transactional data contained in the datasets 501 to aggregated data for inflating the graph(s) associated with the data. These expressions are used by the business model calculator 505 to prepare an in-memory or storage-based business model correlating to the data calculated for a specific dimension set. More specifically, the business model calculator comprises an expression parser module 506 that parses each expression received for the given nodes 508, and in turn creates a recursive set of instructions that can be interpreted by an expression transformer module 507 to form aggregated data. The expression transformer module 507 completes this task by utilizing the specific instructions received form the expression parser module 506 and the transactional data 510 extracted from the datasets 501 (comprising unique dimensional values) to compute a periodic series of aggregated data. The business model calculator 505 further receives 509 the Dimensional Hierarchy 504 from the business model 502 to define the relationships between the nodes and edges for any unique set of dimensional data associated with the graph. Thus, after the expression parser module 506 provides instructions to the expression transformer module 507, and the steps above are completed, the business model calculator provides an in-memory or storage-based set of nodes/edges that correspond to the graph (or subgraph) and may be used for either (1) execution of an inflation strategy, or (2) provide a user with immediate access to the unique set of dimensional values calculated by the system, which may include accessing via the user interface 516 via the driver graph database 515.

To further illustrate this embodiment, a simplified example of a primary graph for free cash flow 512 may be considered. Free cash flow may be determined from revenue and expenses and represented via nodes on a primary graph 512. One or more of these nodes may contain an expression. For example, the primary graph 512 node REV may comprise the expression “AGG_SUM(RAW(rev))” that causes the expression parser module 506 to instruct that all data in the “rev” column of the dataset 501 be summed to arrive at the aggregate value. Likewise, the primary graph 512 node EXP may comprise the expression “AGG_SUM(RAW(exp))” to calculate aggregated expenses. Node FCF may comprise the expression “SUB(COMPUTED(REV), COMPUTED(EXP)” to create a new metric, wherein the free cash flow is determined by subtracting aggregated expenses from aggregated revenue. In certain embodiments, expressions will be assigned to nodes based on the organizational rules and relationships. In other embodiments, expressions may be predetermined or precomputed before the system and method is activated by a user or machine-driven request. In still other embodiments, the expressions may be stored and accessed in a library, where common expressions for certain nodes and/or relationships are catalogued.

Thus, an output of the business model calculator 505 may be a graph akin to the primary graph 512, wherein the graph represents a unique set of dimensional values with aggregated data mapped to the transactional data of the organization. This mapping permits the same calculation (e.g., free cash flow) to be queried on demand by a user (or a machine) at different times and produce different results, due to the update of data contained in the transactional datasets 501.

In some instances, the system and method may further comprise the execution of an inflation strategy 513. An inflation strategy may occur when a user or machine desires to continue the inflation process and expand the primary graph. This process includes the step of examining the in-memory business model (or graph) and evaluating whether any child nodes/dimensions should be inflated. This process may repeat until all possible child nodes in the graph are populated, thereby creating additional sets of dimension nodes. In embodiments, this inflation strategy 513 occurs autonomously when the user requests information requiring primary graph inflation. Here again, the inflation strategy if performed on demand, such that computing and other resources are not constrained unnecessarily, and such that any area of the business, at any level of detail without limitation, can be analyzed provided the data has been provided.

The systems and methods described herein are preferably configured to run on a computer server or similar computational machinery. The system/modules may be stored or operated on a computing environment, wherein the devices, servers, modules, etc. may execute. The computing environment preferably includes one or more user computers. The computers may be general purpose personal computers (including, merely by way of example, personal computers, and/or laptop computers running various versions of Microsoft Corporation's Windows® and/or Apple Corporation's Macintosh® operating systems) and/or workstation computers running any of a variety of commercially available UNIX® or UNIX-like operating systems.

User computers may also have any of a variety of applications, including for example, database client and/or server applications, and web browser applications. Alternatively, the user computers may be any other electronic device, such as a thin-client computer, Internet-enabled mobile telephone, and/or personal digital assistant, capable of communicating via a network and/or displaying and navigating web pages or other types of electronic documents. Any number of user computers may be supported.

The computing environment described according to this embodiment preferably includes at least one network. The network can be any type of network familiar to those skilled in the art that can support data communications using any of a variety of commercially available protocols, including without limitation SIP, TCP/IP, SNA, IPX, AppleTalk, and the like. Merely by way of example, the network may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth® protocol known in the art, and/or any other wireless protocol); and/or any combination of these and/or other networks.

The system in varying embodiments may also include one or more server computers. One server may be a web server, which may be used to process requests for web pages or other electronic documents from user computers. The web server can be running an operating system including any of those discussed above, as well as any commercially available server operating systems. The web server can also run a variety of server applications, including SIP servers, HTTP servers, FTP servers, CGI servers, database servers, Java servers, and the like. In some instances, the web server may publish operations available operations as one or more web services.

According to certain embodiments, the computing environment may also include one or more file and or/application servers, which can, in addition to an operating system, include one or more applications accessible by a client running on one or more of the user computers. The server(s) may be one or more general purpose computers capable of executing programs or scripts in response to the user computers. As one example, the server may execute one or more web applications. The web application may be implemented as one or more scripts or programs written in any programming language, such as Java™, C, C#, or C++, and/or any scripting language, such as Perl, Python, or TCL, as well as combinations of any programming/scripting languages. The application server(s) may also include database servers, including without limitation those commercially available from Oracle, Microsoft, Sybase™ IBM™ and the like, which can process requests from database clients running on a user computer.

In embodiments, the web pages created by the application server may be forwarded to a user computer via a web server. Similarly, the web server may be able to receive web page requests, web services invocations, and/or input data from a user computer and can forward the web page requests and/or input data to the web application server. In further embodiments, the server may function as a file server. Although the foregoing generally describes a separate web server and file/application server, those skilled in the art will recognize that the functions described with respect to servers may be performed by a single server and/or a plurality of specialized servers, depending on implementation-specific needs and parameters. The computer systems, file server and/or application server may function as an active host and/or a standby host.

In embodiments, the computing environment may also include a database. The database may reside in a variety of locations. By way of example, database may reside on a storage medium local to (and/or resident in) one or more of the computers. Alternatively, it may be remote from any or all of the computers, and in communication (e.g., via the network) with one or more of these. In a particular embodiment, the database may reside in a storage-area network (“SAN”) familiar to those skilled in the art. Similarly, any necessary files for performing the functions attributed to the computers may be stored locally on the respective computer and/or remotely, as appropriate. In one set of embodiments, the database may be a relational database, which is adapted to store, update, and retrieve data in response to SQL or equivalently formatted commands.

The computer system may also comprise software elements, including but not limited to application code, within a working memory, including an operating system and/or other code. It should be appreciated that alternate embodiments of a computer system may have numerous variations from that described above. For example, customized hardware might also be used and/or particular elements might be implemented in hardware, software (including portable software, such as applets), or both. Further, connection to other computing devices such as network input/output devices may be employed.

According to one embodiment, the server may include one or more components that may represent separate computer systems or electrical components or may include software executed on a computer system. These components include a load balancer, one or more web servers, a database server, and/or a database. The load balancer is operable to receive a communication from the mobile device and can determine to which web server to send the communication. Thus, the load balancer can manage, based on the usage metrics of the web servers, which web server will receive incoming communications. Once a communication session is assigned to a web server, the load balancer may not receive further communications. However, the load balancer may be able to redistribute load amongst the web servers if one or more web servers become overloaded.

In embodiments, one or more web servers are operable to provide web services to the user devices. In embodiments, the web server receives data or requests for data and communicates with the database server to store or retrieve the data. As such, the web server functions as the intermediary to put the data in the database into a usable form for the user devices. There may be more or fewer web servers, as desired by the operator.

In this embodiment, a database server is any hardware and/or software operable to communicate with the database and to manage the data within the database. Database servers, for example, SQL server, are well known in the art and will not be explained further herein. The database can be any storage mechanism, whether hardware and/or software, for storing and retrieving data. The database can be as described further herein.

In embodiments, the system may comprise an adaptive learning capability wherein, if a relationship between the at least one input and the decision tree node cannot be determined, a machine learning engine is further provided and configured to process the at least one input. By way of example but not limitation, embodiments disclosed herein further comprise the ability to generate one or more nodes associated with a decision tree. The system further comprises the ability to either manually pre-populate a set of nodes or automatically create a set of nodes for the new decision tree. In embodiments, the new decision tree may be associated with a particular business-specific data repository. Embodiments disclosed herein include receiving an input and associating a set of inputs to one or more nodes in the new decision tree. The new decision tree may be based upon a template created by a user.

In the foregoing description, for the purposes of illustration, systems and methods were described in a particular order. It should be appreciated that in alternate embodiments, the methods may be performed in a different order than that described. It should also be appreciated that the methods described above may be performed by hardware components or may be embodied in sequences of executable instructions on machine-readable media, and which cause a machine, such as a general-purpose or special-purpose processor or logic circuits programmed with the instructions to perform the methods. These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the Figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A system for autonomously organizing and analyzing data associated with an organization, comprising:
a source of transactional data that comprises temporal, geographical and other types of metadata about a plurality of transactions, the source data acquired by way of flat files, databases internal to the organization or third-party databases;
a processor operating on specially configured computational machinery, wherein the processor is programmed to:
retrieve and validate structured data from the data source;
transform the data into a graphical format to comport with a predetermined dataset format;
construct and store in a data storage medium a directed primary graph that comprises a plurality of Primary Nodes and Dimension Nodes configured to represent one or more relationships between organizational business metrics, wherein each Primary Node contains a unique identifier that is used by the inflation function below to generate the driver graph;
construct and store in the data storage medium, hierarchical trees for one or more business dimension, wherein each Dimension Node contains a unique identifier that is used by an inflation function to generate the driver graph; and
a driver graph generation module, comprising:
a driver graph node indexer that determines the combination of unique Primary Nodes and unique Dimension Nodes for modeling transactional data processing into a Primary Driver Graph;
a mapping function, wherein the mapping function aggregates the transactional data based on the unique set of Primary Node and Dimension Nodes determined by the driver graph node indexer;
a business metric relationship function used by the mapping function to correctly aggregate the transactional data based on the business metrics' relationships as stored within the Primary Driver Graph;
the inflation node function, wherein each combination of the unique set of Primary Nodes and Dimension Nodes is generated as a product of the Primary Driver Graph and each Dimension Graph, and wherein each combination is then used to transform the transactional business data, using the driver graph node indexer, the mapping function, and the business metric relationship function, into a Driver Graph Node;
an inflation edge function, wherein all Driver Graph Nodes are then connected by Driver Graph Edges that are the result of the cartesian product of the Primary Graph and each Dimension Graph; and
a storing function, wherein in-memory node and edge data are translated and stored in the data storage medium.

2. The system of claim 1, wherein the predetermined dataset format comprises a period, at least a first dimension and at least a first metric.

3. The system of claim 2, wherein the at least a first dimension comprises one or more dimensional levels.

4. The system of claim 2, wherein the processor is further programmed to retrieve unstructured data from the data source.

5. The system of claim 1 further comprising an application server in communication with the driver graph generation module.

6. The system of claim 5, wherein the application server is in communication with a display server configured to display at least a portion of the initial driver graph or a portion of a subsequent graph to a user through one or more user interfaces.

7. The system of claim 1 further comprising an analytics engine, the analytics engine comprising a correlation tool for analyzing the conjoint present and future behavior of multiple Driver Nodes and generate patterns of anomalies that match a single specific internal or external business event.

8. The system of claim 1 further comprising an anomaly detection function, wherein the anomaly detection function is configured to detect an unexpected state of at least one Driver Node in comparison to the retrieved structured data of the at least one Driver Node and the structure of the complete graph.

9. The system of claim 8, wherein the anomaly detection function is configured to perform root cause focusing by identifying and evaluating potential causes of the unexpected state of at least one node at a predetermined distance removed from the at least one node in relation to the complete graph.

10. The system of claim 1 further comprising a forecasting engine, the forecasting engine configured to predict outcomes based upon one or more Driver Nodes in the driver graph.

11. The system of claim 1 further comprising the step of incorporating data external to the business and determining statistical impact on a Driver Node so as to be considered a Probabilistic Driver and incorporated into the Driver Graph as Probabilistic Driver Nodes and Probabilistic Driver Edges.

12. The system of claim 1, wherein the transactions comprise sales transactions, operational transactions, human and machine behavior-driven events, business events, business activities, market events, market activities, consumer-based transactions and financial events.

13. The system of claim 1, wherein the processor is programmed to retrieve and validate structured data from the data source using a structure learning function, and wherein the primary graph generation module is configured to regenerate the initial Primary Driver Graph based upon at least one of:
a change in the dimensional hierarchy database;
a change occurring in the transformed data;
an error determination made by the driver graph generation module; or
an instruction to validate the initial primary graph.

14. The system of claim 1, wherein the plurality of transactions comprises aggregated transactions.

15. The system of claim 7, wherein the correlation tool is replaced or supplemented by a clustering tool.
